(19) United States
(12) Patent Application Publication
(10) Pub. No.: US 2008/0117120 A1
(43) Pub. Date: May 22, 2008

(54) Receiver of FM System

(76) Inventors: Saou-Wen Su, Taipei City (TW); Wei-Hao Yeh, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/747,916

(22) Filed: May 14, 2007

(30) Foreign Application Priority Data
Nov. 20, 2006 (TW) 095142806

(51) Int. Cl. H01Q 1/36

(52) U.S. Cl. 343/895

(57) ABSTRACT

A receiver of a frequency modulation (FM) system includes a first dielectric substrate, a second dielectric substrate, a helix antenna and an FM module. The helix antenna is formed between the first dielectric substrate and the second dielectric substrate and has a first end and a second end opposite to the first end. Thereby, a central axis of the helix antenna is approximately parallel to a side of the first dielectric substrate. The FM module is formed on the first dielectric substrate and electronically connected to the first end of the helix antenna. Besides, the FM module is used for transforming high-frequency signals received by the helix antenna into intermediate-frequency signals.

### BACKGROUND OF THE INVENTION

1. Field of the Invention

The present invention relates to a receiver of a frequency modulation (FM) system, and more particularly, to a receiver capable of reducing size of itself and enhancing reception efficiency of the FM system.

2. Description of the Prior Art

Frequency modulation broadcasting system (FM system) is a broadcasting system utilizing a frequency modulation technique to transmit audio signals. Compared with amplitude modulation (AM) broadcasting system, the FM system has advantages of constant envelope, capabilities of anti-nonlinear-distortion and anti-fading-effect, etc. Thus, the FM system has better signal quality and is capable of transmitting stereo signals, which includes left and right channel signals.

A receiver (ex. radio) of the FM system receives FM signals through an antenna, and outputs audio signals after frequency-down-conversion, demodulation, and related operations. Therefore, the main factor of audio quality outputted by the radio depends on reception efficiency of the antenna. In the prior art, the majority of FM antennas are external antennas, and rod monopole antennas and dipole antennas covered with PolyEthylen (PE) are representatives.

Please refer to FIG. 1 and FIG. 2, which are schematic diagrams of a rod monopole antenna 10 and a PE dipole antenna 20. The rod monopole antenna 10 is commonly fixed on a corner of a housing of a portable stereo or a handy radio. When a user wants to listen to broadcasting programs, the user needs to draw out the rod monopole antenna 10 to a specific length. When the rod monopole antenna 10 is not used, the user can deposit the rod monopole antenna 10 in order to save space. Since the rod monopole antenna 10 needs to be drawn out to a certain length about 76 cm in use condition, the rod monopole antenna 10 is easily broken, space wasting, and deficient in esthetic appearance. On the contrary, the PE dipole antenna 20 is commonly applied to mounted stereo facilities, and can prevent from being broken. However, the price of the PE dipole antenna 20 is high, about US$ 1, and a long transmission line 200 connecting radiating metal layers 202, 204 of the PE dipole antenna 20 with an antenna plug set on the stereo facility is needed, which makes the PE dipole antenna 20 to be entwisted and knot.

In brevity, the rod monopole antenna 10 has a larger size and exposes on a housing of a portable or handy radio, so that the rod monopole antenna 10 is easily broken by external force, wastes space and lacks esthetic appearance. The PE dipole antenna 20 costs higher price, and is easily entwisted and knots. Architecture of these antennas not only makes users more inconvenient in use but also lacks esthetic appearance. In order to improve the above-mentioned problems of exposure antennas, it is necessary to design a hidden antenna with impedance and bandwidth suitable for requirements of the FM system. TW patent No. M283445 “Mobile Phone with FM Antenna” discloses a minimized hidden antenna, which is assembled on two sides and the bottom of the mobile phone. In such architecture, the antenna is often too close to the ground plane so that the antenna commonly has great capacitance and inductance. Impedance matching of the antenna becomes worse, effecting signal quality of the FM antenna. In addition, TW patent No. 200620752 “Antenna for Mobile Terminal and Mobile Terminal” discloses an antenna composed of various units including an antenna element installed on a housing and a metal coil hidden inside the housing. Such architecture often combines metal coils of the antenna with those inside the housing of the mobile phone, which increases the complexity and production cost of the antenna.

### SUMMARY OF THE INVENTION

Therefore, it is a primary object of the present invention to provide a receiver of a frequency modulation (FM) system.

The present invention discloses a receiver of an FM system. The receiver comprises a first dielectric substrate, a second dielectric substrate, a helix antenna and an FM module. The helix antenna is formed between the first dielectric substrate and the second dielectric substrate and has a first end and a second end opposite to the first end. Thereby, a central axis of the helix antenna is approximately parallel to a side of the first dielectric substrate. The FM module is formed on the first dielectric substrate and electronically connected to the first end of the helix antenna. Besides, the FM module is used for transforming high-frequency signals received by the helix antenna into intermediate-frequency signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a rod monopole antenna according to the prior art.

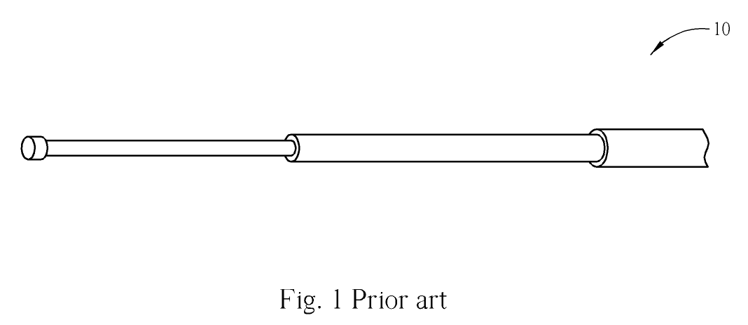

FIG. 2 is a schematic diagram of a PolyEthylen (PE) dipole antenna according to the prior art.

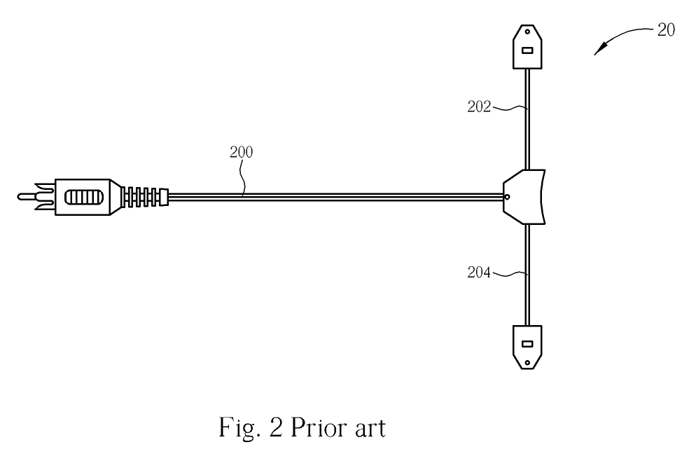

FIG. 3 is a schematic diagram of a receiver of an FM system according to the present invention.

FIG. 4 is a vertical perspective-view diagram of the receiver shown in FIG. 3.

FIG. 5 is a measurement result of return loss of the helix antenna shown in FIG. 3.

FIG. 6 is an embodiment of the helix antenna shown in FIG. 3.

FIG. 7 is an embodiment of the helix antenna shown in FIG. 3.

### DETAILED DESCRIPTION

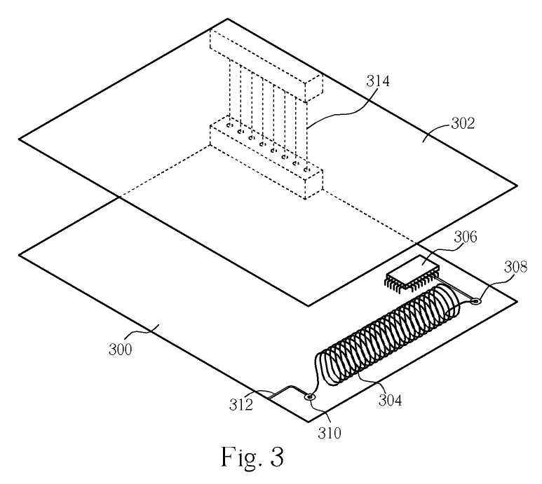

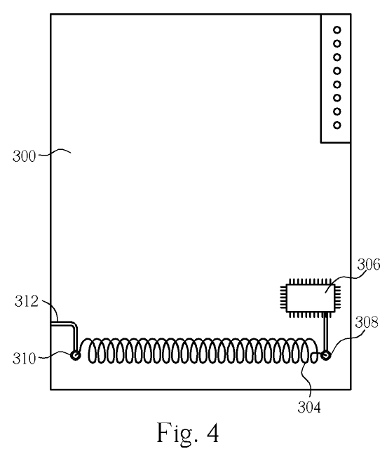

Please refer to FIG. 3 and FIG. 4. FIG. 3 is a schematic diagram of a receiver 30 of an FM system according to the present invention, while FIG. 4 is a vertical perspective-view diagram of the receiver 30. The receiver 30 includes a first dielectric substrate 300, a second dielectric substrate 302, a helix antenna 304, and an FM module 306. The helix antenna 304 is formed between the first dielectric substrate 300 and the second dielectric substrate 302, and includes a first end 308 and a second end 310 opposite to the first end 308. An axis of the helix antenna 304 is approximately parallel to a side of the first dielectric substrate 300. The FM module 306 is formed on the first dielectric substrate 300 and includes a signal end (not shown in FIG. 3) electronically connected to the first end 308 of the helix antenna 304, utilized for transforming high-frequency signals received by the helix antenna 304 into intermediate-frequency signals. Besides, a printing transmission line 312 is formed on the first dielectric substrate 300 and electronically connected between the second end 310 of the helix antenna 304 and a connector (not shown in FIG. 3). Between the first dielectric substrate 300 and the second dielectric substrate 302 is a bus set 314, utilized for electronically connecting the first dielectric substrate 300 and the second dielectric substrate 302.

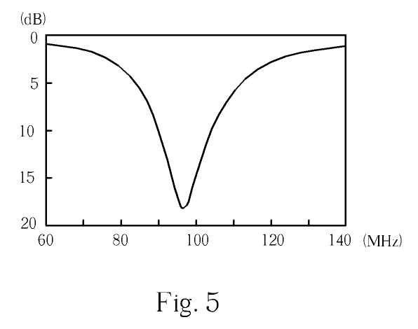

As shown in FIG. 3, the first dielectric substrate 300 and the second dielectric substrate 302 are approximately parallel. The present invention utilizes these two dielectric substrates to generate the effect of frequency shift shielding, so as to enhance reception efficiency of the helix antenna 304. Firstly, as those skilled in the art recognized, ¼ the wavelength of the central operating frequency in the FM band (88˜108 MHz) is about 76 cm. That is to say, in theory, a monopole antenna can obtain best performance when the monopole antenna is longer than 76 cm. Secondly, the operating frequency band of the FM system is within Very High Frequency (VHF) band, so that in comparison with microwave band (over 1 GHz), the FM system is sort of a low frequency system. In general, a low frequency antenna has a larger size, and in condition that the system ground plane is very small corresponding to the operating wavelength, impedance of the antenna becomes greater and the antenna is inductive, meaning that the antenna impedance is unmatched and reception efficiency of electromagnetic radiation is poor. In the present invention, the parallel dielectric substrates 300, 302 can provide capacitive impedance to compensate great inductive impedance of the low frequency antenna, so that reception efficiency of electromagnetic radiation of the helix antenna 304 can increase. Since the helix antenna 304 is close to the ground planes of the two dielectric substrates, which means that the ground planes are close to the main radiating element of the antenna, the total length of the antenna can be downscaled. As a result, preferably, the coil number of the helix antenna 304 is about 26, the diameter of the helix antenna 304 is about 6 mm, and the total length of the coil is about 50 cm (corresponding to a operating frequency 150 MHz). Under this circumstance, the helix antenna 304 can obtain excellent measurement result of return loss, as shown in FIG. 5.

By capacitive impedance provided by the first dielectric substrate 300 and the second dielectric substrate 302, the receiver 30 can compensate high inductive impedance of the low frequency antenna, so that reception efficiency of the helix antenna 304 can be increased. In this way, materials of the first dielectric substrate 300, the second dielectric substrate 302, and the helix antenna 304 are not limited, and the helix antenna 304 can perform the measurement result of radiation pattern, as shown in FIG. 5. In addition, since the helix antenna 304 hides between the first dielectric substrate 300 and the second dielectric substrate 302, the receiver 30 can save space, maintain intact appearance, and prevent from being broken.

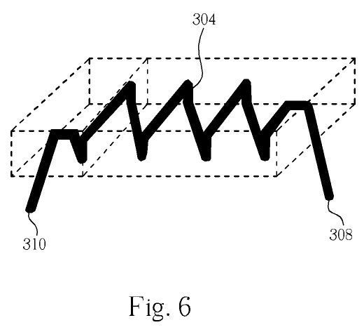

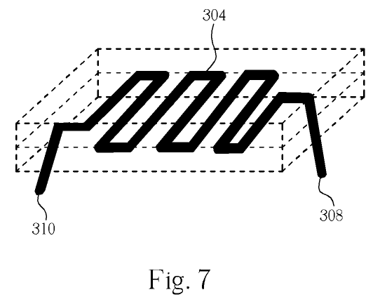

On the other hand, in practice, the helix antenna 304 can be formed by winding a metal line, and is fixed on a device having a high dielectric constant or a dielectric constant approximate to the permittivity of air. Certainly, the helix antenna 304 shown in FIG. 3 and FIG. 4 is just an embodiment of the present invention, and any instances, capable of satisfying operating frequency band of the FM system and being hidden between the first dielectric substrate 300 and the second dielectric substrate 302, can be applied to the present invention, for example, embodiments shown in FIG. 6 and FIG. 7.

In summary, the present invention receiver 30 has advantages of simple architecture, low production cost, esthetic appearance, and good antenna performance. In addition, impedance of the present invention receiver 30 satisfies the operating frequency band of the FM system. Thus, the receiver 30 is much suitable for handy multimedia display devices, so as to maintain intact appearance and enhance electromagnetic reception efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A receiver of a frequency modulation (FM) system comprising:
a first dielectric substrate;
a second dielectric substrate;
a helix antenna formed between the first dielectric substrate and the second dielectric substrate, having a first end and a second end opposite to the first end, wherein a central axis of the helix antenna is approximately parallel to a side of the first dielectric substrate; and
an FM module formed on the first dielectric substrate and electronically connected to the first end of the helix antenna, for transforming high-frequency signals received by the helix antenna into intermediate-frequency signals.

2. The receiver of claim 1, wherein the first dielectric substrate is approximately parallel to the second dielectric substrate.

3. The receiver of claim 1 further comprising a bus electronically connected between the first dielectric substrate and the second dielectric substrate.

4. The receiver of claim 1, wherein the first end of the helix antenna is electronically connected to a signal end of the FM module.

5. The receiver of claim 1 further comprising a first printing transmission line formed on the first dielectric substrate, having one end electronically connected to the second end of the helix antenna.

6. The receiver of claim 5, wherein one end of the first printing transmission line far from the helix antenna is electronically connected to a connector.

7. The receiver of claim 1, wherein the helix antenna is formed by winding a metal line and is fixed on a device having a dielectric constant approximate to a permittivity of air.

8. The receiver of claim 1, wherein the helix antenna is formed by winding a metal line and is fixed on a device having a high dielectric constant.
